(19) United States
(12) Patent Application Publication
(10) Pub. No.: US 2024/0061113 A1
(43) Pub. Date: Feb. 22, 2024

(54) INFORMATION PROCESSING APPARATUS, INFORMATION PROCESSING SYSTEM, INFORMATION PROCESSING METHOD, AND NON-TRANSITORY COMPUTER READABLE MEDIUM

(71) Applicant: NEC Corporation, Minato-ku, Tokyo (JP)

(72) Inventor: Akira Tsuji, Tokyo (JP)

(73) Assignee: NEC Corporation, Minato-ku, Tokyo (JP)

(21) Appl. No.: 18/271,429

(22) PCT Filed: Jan. 14, 2021
(86) PCT No.: PCT/JP2021/000967

§ 371 Date: Jul. 7, 2023

(51) Int. Cl. G01S 17/08; G01B 11/02

(52) U.S. Cl. CPC G01S 17/08; G01B 11/026

(57) ABSTRACT

An information processing apparatus according to the present disclosure includes: a first acquisition unit that acquires first point group data indicating a distance between a sensor and an object to be measured at a first measurement spot along a path; a second acquisition unit that acquires second point group data indicating a distance between a sensor and the object to be measured at a second measurement spot different from the first measurement spot along the path; a division unit that divides point group data including the first point group data and the second point group data into one or a plurality of segments; a distribution calculation unit that calculates a distribution of the point group data in the segment; and a removal unit that removes an outlier value from the point group data in the segment, based on the distribution.

### TECHNICAL FIELD

The present disclosure relates to an information processing apparatus, an information processing system, an information processing method, and a non-transitory computer readable medium.

### BACKGROUND ART

A sensor such as LiDAR can irradiate each measurement point of an object to be measured with a laser and calculate a distance to each measurement point, based on a time from the irradiation of the laser until light reception. By using such a sensor while moving, it is possible to acquire a distance to an object to be measured, such as a tunnel, and a shape thereof.

For example, Patent Literature 1 discloses a wireless communication system that collects point group data including measurement data at a plurality of measurement points which are measured by a sensor installed on a roadside or a vehicle. The collected measurement data are transmitted to a server, and by detecting a vehicle or a pedestrian in the server, the collected measurement data may be used for driving assistance. Further, in this wireless communication system, when the measurement data include a large number of measurement points of a static target object such as a fixed object, such as a building or a tree, or a ground, there is a problem that communication traffic to be transmitted from a transmission apparatus to the server increases. In order to solve this problem, Patent Literature 1 proposes removing, from the point group data, measurement data of measurement points constituting a trajectory of a predetermined threshold length or more and measurement data of measurement points included in a predetermined angle range.

### CITATION LIST

### Patent Literature

[Patent Literature 1] International Patent Publication No. WO 2019/131075

### SUMMARY OF INVENTION

### Technical Problem

However, when such filtering is performed with a fixed threshold value, there is a problem that, when a distance between an object to be measured and a sensor is not constant due to a case where the sensor is not moving parallel to the target object or the like, originally necessary data are removed.

The present disclosure is made in order to solve such a problem, and an object of the present disclosure is to provide an information processing apparatus, an information processing system, an information processing method, and a non-transitory computer readable medium that remove unnecessary data from point group data measured by moving a sensor without removing originally necessary data.

### Solution to Problem

An information processing apparatus according to a first aspect of the present disclosure includes: a first acquisition unit configured to acquire first point group data indicating a distance between a sensor and an object to be measured at a first measurement spot along a path; a second acquisition unit configured to acquire second point group data indicating a distance between a sensor and the object to be measured at a second measurement spot different from the first measurement spot along the path; a division unit configured to divide point group data including the first point group data and the second point group data into one or a plurality of segments; a distribution calculation unit configured to calculate a distribution of the point group data in the segment; and a removal unit configured to remove an outlier value from the point group data in the segment, based on the distribution.

An information processing system according to a second aspect of the present disclosure includes: a sensor configured to, while moving a sensor along a path, irradiate an object to be measured with a laser from the sensor, receive reflected light, and thereby acquire point group data acquired by measuring a distance from the sensor to the object to be measured; a first acquisition unit configured to acquire first point group data indicating a distance between the sensor and the object to be measured at a first measurement spot along the path; a second acquisition unit configured to acquire second point group data indicating a distance between the sensor and the object to be measured at a second measurement spot different from the first measurement spot along the path; a division unit configured to divide point group data including the first point group data and the second point group data into a plurality of segments; a distribution calculation unit configured to calculate a distribution of the point group data in the segment; and a removal unit configured to remove an outlier value from the point group data in the segment, based on the distribution.

An information processing method according to a third aspect of the present disclosure includes: acquiring first point group data indicating a distance between a sensor and an object to be measured at a first measurement spot along a path; acquiring second point group data indicating a distance between a sensor and the object to be measured at a second measurement spot different from the first measurement spot along the path; dividing point group data including the first point group data and the second point group data into one or a plurality of segments; calculating a distribution of the point group data in the segment; and removing an outlier value from the point group data in the segment, based on the distribution.

A non-transitory computer readable medium stores a program according to a fourth aspect of the present disclosure, the program causing a computer to execute: processing of acquiring first point group data indicating a distance between a sensor and an object to be measured at a first measurement spot along a path; processing of acquiring second point group data indicating a distance between a sensor and the object to be measured at a second measurement spot different from the first measurement spot along the path; processing of dividing point group data including the first point group data and the second point group data into one or a plurality of segments; processing of calculating a distribution of the point group data in the segment; and processing of removing an outlier value from the point group data in the segment, based on the distribution.

### Advantageous Effects of Invention

According to the present disclosure, it is possible to provide an information processing apparatus and the like that remove unnecessary data from point group data measured by moving a sensor without removing originally necessary data.

### BRIEF DESCRIPTION OF DRAWINGS

FIG. 1 is a block diagram illustrating a configuration of an information processing apparatus according to a first example embodiment;

FIG. 2 is a flowchart illustrating an information processing method according to the first example embodiment;

FIG. 3 is a diagram illustrating an example of measuring an inner wall of a tunnel with a sensor mounted on a moving body;

FIG. 4 is a diagram explaining a first reason that a luminance value is not stable;

FIG. 5 is a diagram illustrating a distribution of luminance values before filtering;

FIG. 6 is a diagram illustrating a distribution of luminance values after filtering;

FIG. 7 is a diagram illustrating an example in which a hole is located in a part of an object to be measured by a sensor;

FIG. 8 is a diagram illustrating an example in which measurement data that are not to be filtered are filtered;

FIG. 9 is an example in which a part of an object to be measured by a sensor has a slope;

FIG. 10 is a diagram illustrating an example in which measurement data that are not to be filtered are filtered;

FIG. 11 is a diagram explaining a filtering method based on a distribution of distances according to some example embodiments;

FIG. 12 is a diagram explaining a filtering method based on a distribution of distances according to some example embodiments;

FIG. 13 is a diagram explaining a filtering method according to a distribution of angles of incidence according to some example embodiments;

FIG. 14 is a diagram explaining an example of calculating an angle of incidence of a laser;

FIG. 15 is a block diagram illustrating a configuration of an information processing apparatus according to a second example embodiment;

FIG. 16 is a block diagram illustrating a configuration of an information processing system according to a third example embodiment; and

FIG. 17 is a block diagram illustrating an example of a hardware configuration of an information processing apparatus according to some example embodiments.

### EXAMPLE EMBODIMENT

Hereinafter, example embodiments of the present disclosure will be explained in detail with reference to the drawings. In each of the drawings, the same or relevant elements are denoted by the same reference numerals, and repetition explanations are omitted as necessary for clarity of explanation.

### First Example Embodiment

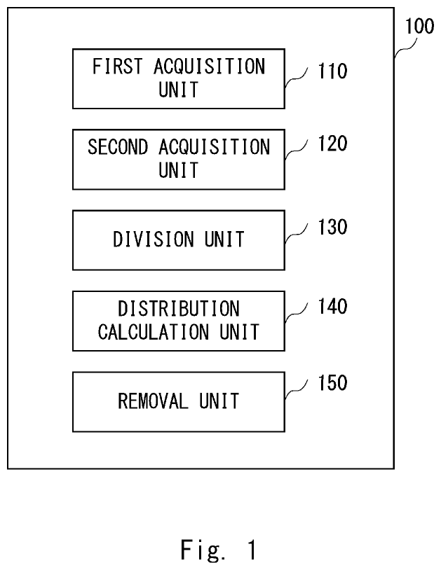

FIG. 1 is a block diagram illustrating a configuration of an information processing apparatus according to a first example embodiment.

An information processing apparatus 100 is achieved by a computer including a processor, a memory, and the like. The information processing apparatus 100 may be used in order to acquire point group data from a sensor that measures an object to be measured and analyze the point group data. The sensor may be a radar sensor (for example, LiDAR) that measures a distance to a measurement point. Specifically, the information processing apparatus 100 includes a first acquisition unit 110, a second acquisition unit 120, a division unit 130, a distribution calculation unit 140, and a removal unit 150.

The first acquisition unit 110 acquires first point group data indicating a distance between a sensor and an object to be measured at a first measurement spot along a path. The second acquisition unit 120 acquires second point group data indicating a distance between the sensor and the object to be measured at a second measurement spot different from the first measurement spot along the path.

In general, the sensor is mounted on a moving body (for example, a vehicle) or the like, moves to a first measurement spot and a second measurement spot, irradiates the object to be measured with a laser, and receives reflected light, thereby acquiring point group data indicating a distance between the sensor and the object to be measured. However, the sensor in the present invention is not limited thereto. For example, a person may carry a sensor and measure a distance while moving. The sensor at the first measurement spot may be different from the sensor at the second measurement spot. For example, when a tunnel is long, the distance can be measured by a plurality of sensors (for example, every predetermined distance).

The division unit 130 divides point group data including the first point group data and the second point group data into one or a plurality of segments. The segment is a small region that divides point group data acquired from a plurality of measurement points. The segment includes one or more points of the point group data. The segment may have a three-dimensional shape such as a sphere, a cuboid, or a cube when the object to be measured is a three-dimensional object. When (at least) a part of the object to be measured is planar, the segment may assume to have a plane surface such as a circle, a rectangle, or a square, and extract a point in the vicinity of this plane surface. A size of the segment can be optionally set in consideration of a size of a portion of interest (for example, a crack, a depression, a hole, or the like) in the object to be measured. The size of each segment may be the same as or different from each other.

The distribution calculation unit 140 calculates a distribution of the point group data in the segment. The distribution calculation unit 140 can calculate, for example, a distribution of distances from the sensor to the object to be measured or a distribution of angles of incidence of laser from the sensor to the object to be measured. The distribution calculation unit 140 can calculate the distribution of the distances or the angles of incidence for all the segments. Further, the distribution calculation unit 140 may calculate a distribution of point group data in one or more segments, instead of all the segments.

The removal unit 150 removes an outlier value from the point group data in the segment, based on the calculated distribution. For example, the removal unit 150 may exclude, as an outlier value, a value that is separated from an average value of the distributions by a predetermined threshold value (for example, standard deviations σ, 2σ, 3σ, etc.).

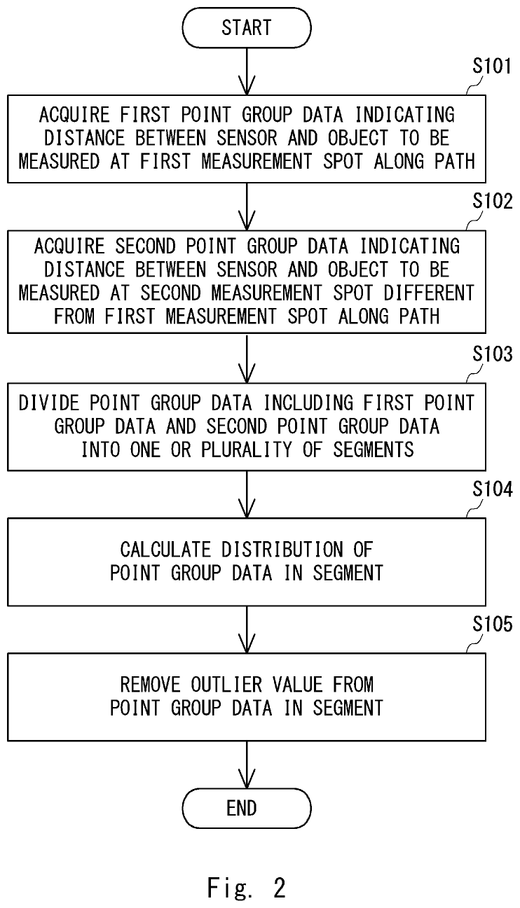

FIG. 2 is a flowchart illustrating an information processing method according to the first example embodiment.

In the information processing method, first point group data indicating a distance between a sensor and an object to be measured at a first measurement spot along the path are acquired (step S101). Second point group data indicating a distance between the sensor and the object to be measured at a second measurement spot different from the first measurement spot along the path are acquired (step S102). Point group data including the first point group data and the second point group data are divided into one or a plurality of segments (step S103). A distribution of the point group data in the segment is calculated (step S104). Based on the distribution, an outlier value is removed from the point group data in the segment (step S105).

In the information processing apparatus and method according to the first example embodiment described above, unnecessary data can be removed from the measured point group data while moving the sensor without removing the originally necessary data.

### Second Example Embodiment

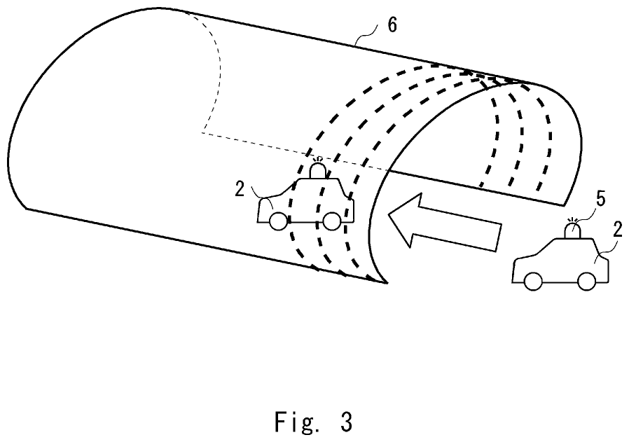

FIG. 3 is a diagram explaining an example of detecting an abnormality in a tunnel by a sensor according to a second example embodiment. In FIG. 3, while a moving body 2 (for example, a vehicle) mounted with a sensor 5 that is a LiDAR travels in a tunnel, an inner wall (object to be measured 6) of the tunnel is irradiated with a laser from the sensor. The sensor then receives the reflected light of the laser from the object to be measured. The sensor may irradiate the laser substantially continuously in a very short period. Alternatively, the moving body 2 may move to an optional position and irradiate the laser at each position. The sensor measures a distance to each measurement point, based on a time from the irradiation of a large number of lasers in a circumferential direction until the reception of the reflected light. Alternatively, the sensor may acquire a luminance value of the reflected light, thereby enabling to estimate a material (for example, metal, fabric, etc.) of the object to be measured. In this way, the sensor can acquire point group data including measurement data at a plurality of measurement points, which are measured by the sensor.

In this example, a small crack in the inner wall of the tunnel is detected based on the acquired point group data. In general, the crack is so small that it cannot be distinguished by a difference in the distance measured by the sensor, i.e., from a shape of the crack. On the other hand, the luminance value indicating an intensity of the reflected light from the crack generally tends to be weak. Therefore, the crack is detected based on the luminance value of the reflected light. However, when the point group data are acquired by scanning the inner wall of the tunnel while moving the sensor, there is a problem that the luminance value included in the point group data is not stable. Therefore, it is also difficult to detect a crack.

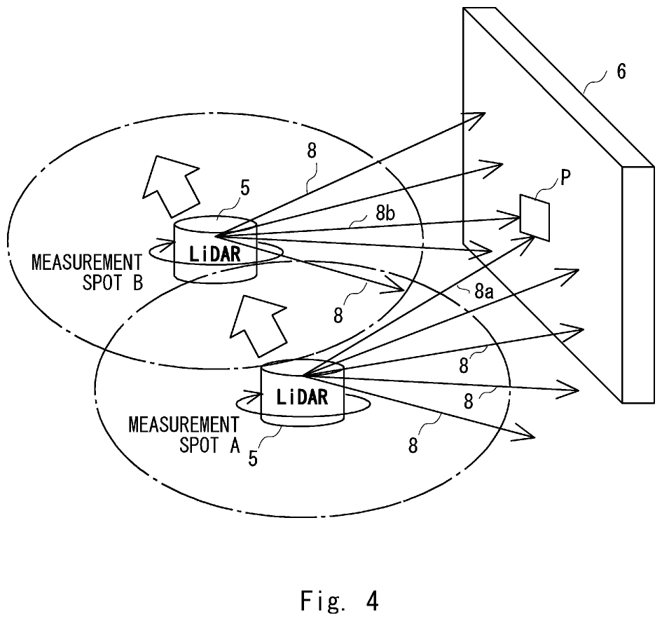

There are two main reasons why the luminance value is not stable. FIG. 4 is a diagram explaining the first reason why the luminance value is not stable. The first reason is that, in a case where the sensor 5 is moved, when lasers 8a and 8b are irradiated from different measurement spots A and B to a same region P of the object to be measured 6, respectively, the sensor 5 receives reflected lights having different distances (trajectories) via the same region P, and as a result, data of points having different luminance values are acquired. Namely, a reflected luminance value acquired by the sensor may be influenced by the distance between the sensor 5 and the object to be measured 6. As the distance between the sensor and the object to be measured increases, the reflected luminance value may decrease. As illustrated in FIG. 4, the sensor irradiates a beam at 3600 around. Therefore, when the measurement is performed while the sensor is moved, each laser from a different position in a movement path of the sensor is irradiated onto the same region of the object to be measured, and data having different luminance values are acquired. Namely, the sensor receives reflected lights of different distances with respect to the same region of the target object, and the reflected lights have different luminance values. Therefore, when the point group data are acquired by scanning the inner wall of the tunnel while moving the sensor, it is considered that the luminance value included in the point group data is not stable.

Further, the second reason is as follows. When the sensor is moved, the lasers 8a and 8b are irradiated to the same region P of the object to be measured 6 from different measurement points A and B. This is because the sensor then receives reflected lights having different angles of incidence via the same region P, and as a result, data having different luminance values are acquired. Namely, the reflected luminance value acquired by the sensor may be influenced by the angle of incidence of the laser from the sensor to the object to be measured. In general, the smaller the angle of incidence of the laser from the sensor to the object to be measured, the smaller the reflected luminance value may be. The sensor also irradiates the beam at 3600 around. Therefore, when the measurement is performed while moving the sensor, each laser beam from a different position in the movement path of the sensor is irradiated onto the same region of the object to be measured, and data having different luminance values are acquired. In other words, the sensor receives reflected lights having different angles of incidence with respect to the same region of the target object, and the reflected lights have different luminance values. Therefore, when the point group data are acquired by scanning the inner wall of the tunnel while moving the sensor, it is considered that the luminance value included in the point group data is not stable.

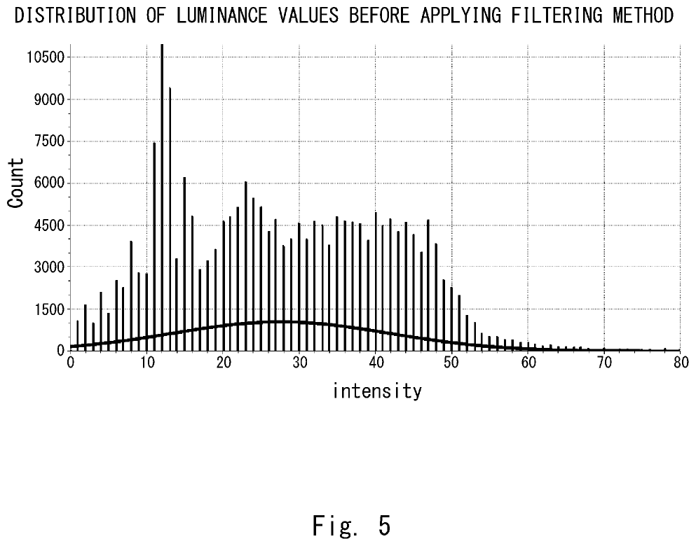

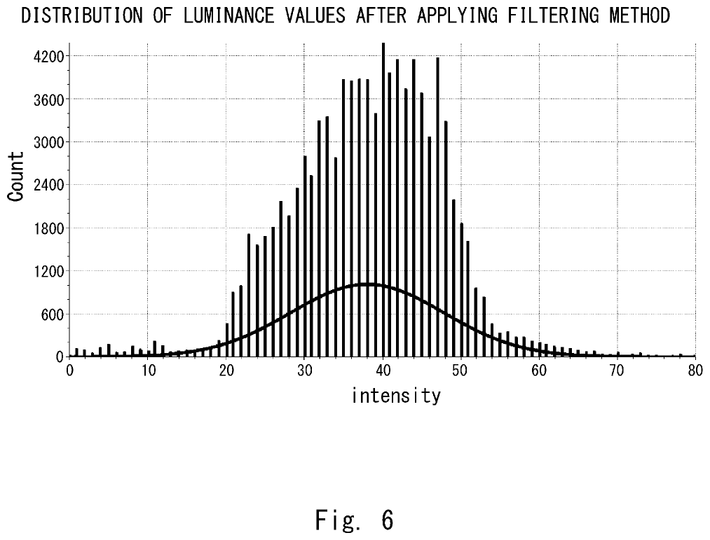

From the above, in order to stabilize the luminance value, a method of removing, from the point group data, reflected light having a distance equal to or greater than a threshold length or removing reflected light having an angle of incidence within a threshold angle (also referred to as filtering using a fixed threshold value) can be considered. With reference to FIGS. 5 and 6, an effect will be explained by filtering using a fixed threshold value. FIG. 5 illustrates a distribution of luminance values before filtering using a fixed length threshold (for example, a distance of 1 m). FIG. 6 illustrates a distribution of luminance values after filtering using a fixed length threshold (for example, a distance of 1 m). In both FIGS. 5 and 6, the horizontal axis indicates the reflected luminance value, and the vertical axis indicates the number of points of the relevant reflected luminance value. As illustrated in FIG. 6, it can be seen that the distribution of the luminance values is gathered in the center as compared with the distribution in FIG. 5, and spread of the distribution (variation in the luminance values) is suppressed.

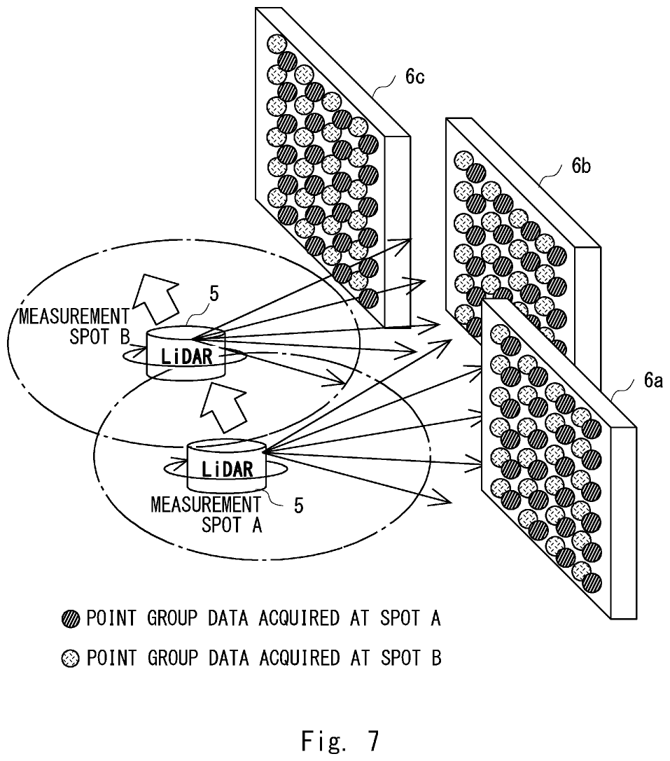

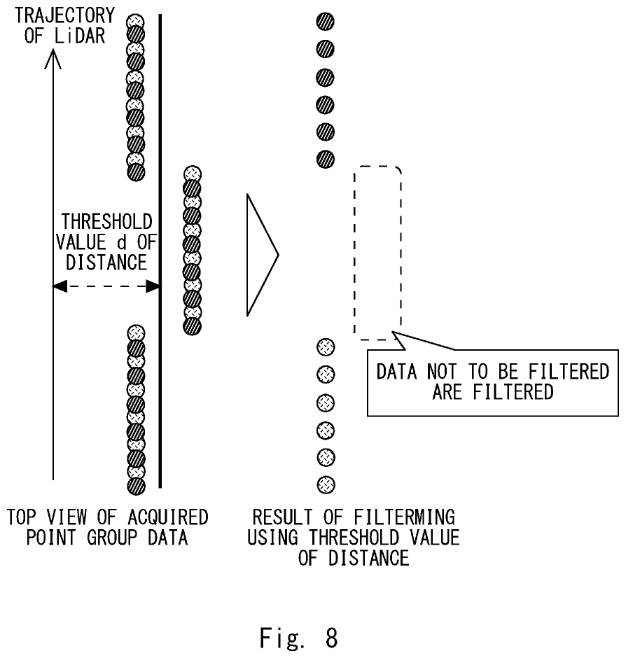

However, when filtering using a fixed threshold value is used, the following problems may occur. FIG. 7 illustrates an example in which a hole (6b in FIG. 7) is located in a part of the object to be measured by the sensor. While moving the sensor 5 near objects to be measured 6a to 6c, each of the objects to be measured is irradiated with a laser at any various spots and measured. In this case, when the objects to be measured 6a and 6c are filtered by a fixed threshold distance, data in which the spread of the distribution is suppressed to some extent can be acquired as described above. On the other hand, the object to be measured 6b is farther away from the movement path of the sensor than the objects to be measured 6a and 6c. In this case, when the filtering is performed by the fixed threshold distance, as illustrated in FIG. 8, measurement data relating to the hole 6b of the object to be measured may be removed. In this way, the measurement data that are not to be originally filtered may be filtered.

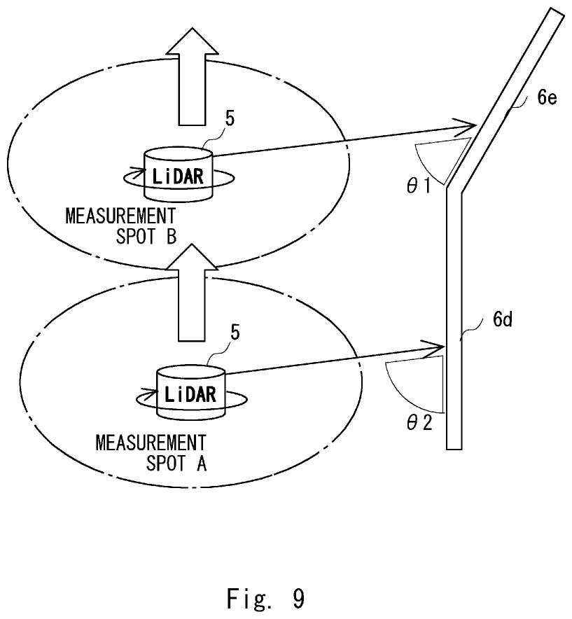

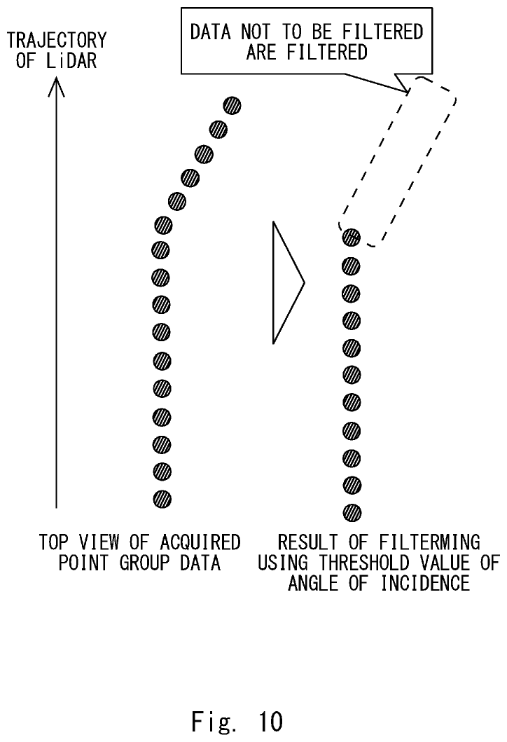

Similarly, FIG. 9 illustrates an example in which a part of the object to be measured by the sensor has an inclined surface. While moving the sensor near the object to be measured, a laser is irradiated to the object to be measured at any various spots, and the object is measured. The object to be measured includes an object to be measured 6d arranged substantially parallel to a movement path of the sensor, and an object to be measured 6e including an inclined surface arranged in such a way as to be gradually separated from the movement path of the sensor. In this case, when filtering is performed by a fixed threshold angle of incidence, as illustrated in FIG. 10, measurement data relating to the inclined surface of the object to be measured 6e may be removed. In this way, the measurement data that are not to be originally filtered may be filtered.

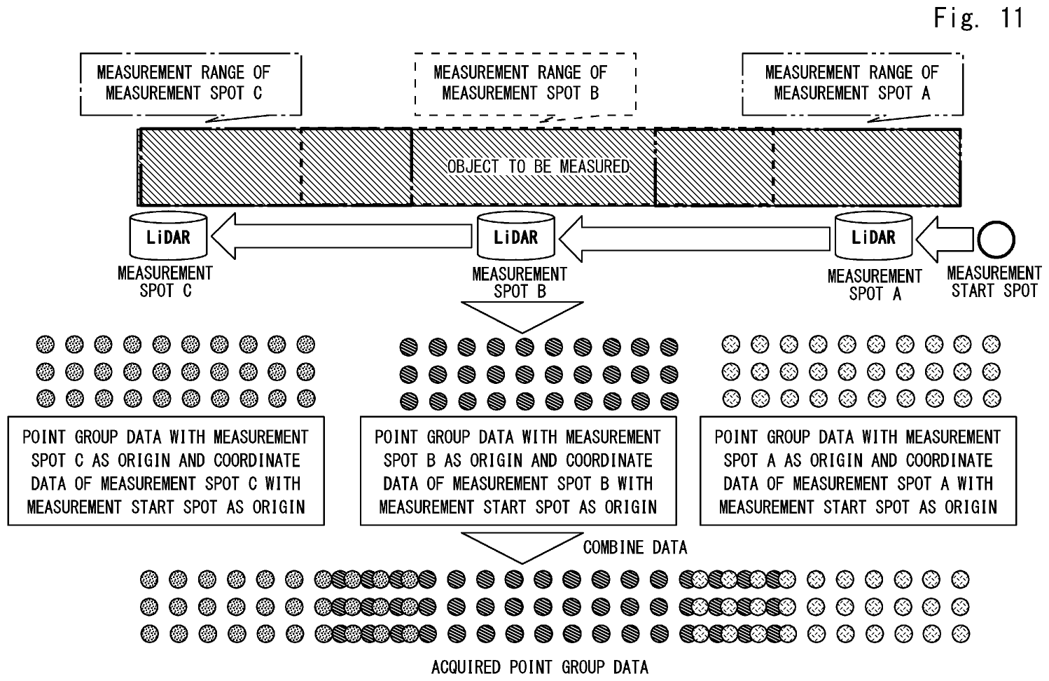

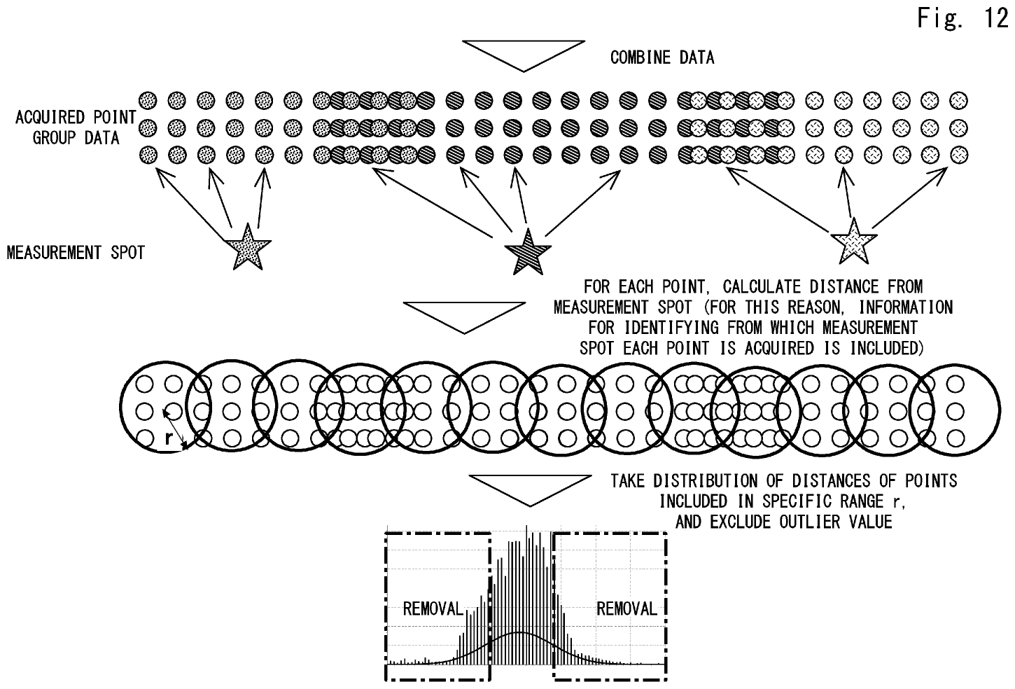

Therefore, in the present example embodiment, the point group data acquired at a plurality of measurement spots are divided into small segments, a distribution of distances from the measurement spot to the measurement point is taken for each segment, and outlier values are excluded. A filtering method based on this distribution will be explained below with reference to FIGS. 11 and 12.

The LiDAR is moved along the path from a measurement start point, and the object to be measured is irradiated with a laser from the LiDAR at each measurement spot (in FIG. 11, measurement spots A, B, and C), and thereafter, the LiDAR receives reflected light.

For the measurement spot A, point group data with the measurement spot A as an origin and coordinate data of the measurement spot A with a measurement start spot as the origin are acquired. For the measurement spot B, point group data with the measurement spot B as the origin and coordinate data of the measurement spot B with the measurement start spot as the origin are acquired. For the measurement spot C, point group data with the measurement spot C as the origin and coordinate data of the measurement spot C with the measurement start spot as the origin are acquired. By using the coordinate data of each of the measurement spots A to C with the measurement start spot as the origin, it is possible to convert the coordinate data (coordinate data A to C) of the measurement data with each of the measurement spots A to C as the origin into coordinate data (coordinate data A′ to C′) with the measurement start spot as the origin. When the coordinate data A′ to C′ acquired in this way are combined, point group data with the measurement start spot as the origin as illustrated in the lower part of FIG. 11 are acquired.

For each point in the point group data, the distance from the measurement spot is calculated. In this case, the point group data may include information for identifying from which measurement spot each point is acquired by the laser. For example, the point group data include the acquired time, and it is possible to recognize a predetermined path and at which measurement position (measurement spots A, B, and C in FIG. 11) each point is acquired, in light of the time.

Next, the point group data of the object to be measured is divided into small segments as illustrated in FIG. 12. When the point group data are three-dimensional data, this segment may be a sphere, or may be a cuboid or a cube (sometimes referred to as a voxel). The size of each segment may be the same as or different from each other. In the present example illustrated in FIG. 12, the point group data are divided into a large number of spheres as segments. Each sphere has the same size (i.e., a sphere with a radius r). For example, a specific point of interest in the point group data may be defined, and a sphere having a radius r centered on the point of interest may be defined as one segment. The point of interest can be optionally set from among points of the point group data. In another example, a specific point of interest among the point group data may be defined, and a predetermined number (for example, 30) of points around the point of interest may be set as one segment.

Note that the point of interest may be all the points of the point group data. Alternatively, for the point of interest, one point randomly extracted from the point group data and a point separated from the extracted point by a predetermined distance may be sequentially extracted.

In the example of FIG. 12, all the points of the point group data are divided in such a way as to be included in each segment, but one or more unnecessary points may be divided in such a way as not to be included in any segment.

For each segment, a distribution of the distances from the measurement spot to the measurement point in the object to be measured is taken, and the outlier values are excluded. The lower graph of FIG. 12 illustrates a distribution of distances for a certain segment. In this graph, the horizontal axis indicates the distance, and the vertical axis indicates the number of points. From the distribution thus acquired, an average value and variance can be calculated, and measurement data exceeding a predetermined threshold value (for example, a positive square root of the variance (an integral multiple of a standard deviation σ, i.e., σ, 2σ, 3σ, etc.) from the average value can be removed from the acquired point group data.

By taking the distribution and excluding the outlier values for each of all the segments, it is possible to acquire optimum point group data in which unnecessary measurement data are removed even when the sensor is moved. By removing data having a long distance and data having a short distance from the point group data, it is possible to acquire data with reduced variation as illustrated in FIG. 6. Further, for example, in the case of the example of FIG. 7, the inner walls 6a and 6b of the object to be measured and the inner wall 6b being the hole are each divided into separate segments, and the distribution of distances between the measurement spot and each point is calculated for each segment. In this way, it is possible to prevent uniform removal of the measurement data relating to the inner wall 6b being a hole, such as filtering by a fixed threshold value. In this way, the size of the segment can be set in consideration of points of interest (for example, depressions, holes, etc.) that may be present in the object to be measured. It is also possible to detect cracks in the inner wall of the tunnel from the luminance value based on the optimum point group data from which unnecessary measurement data have been removed.

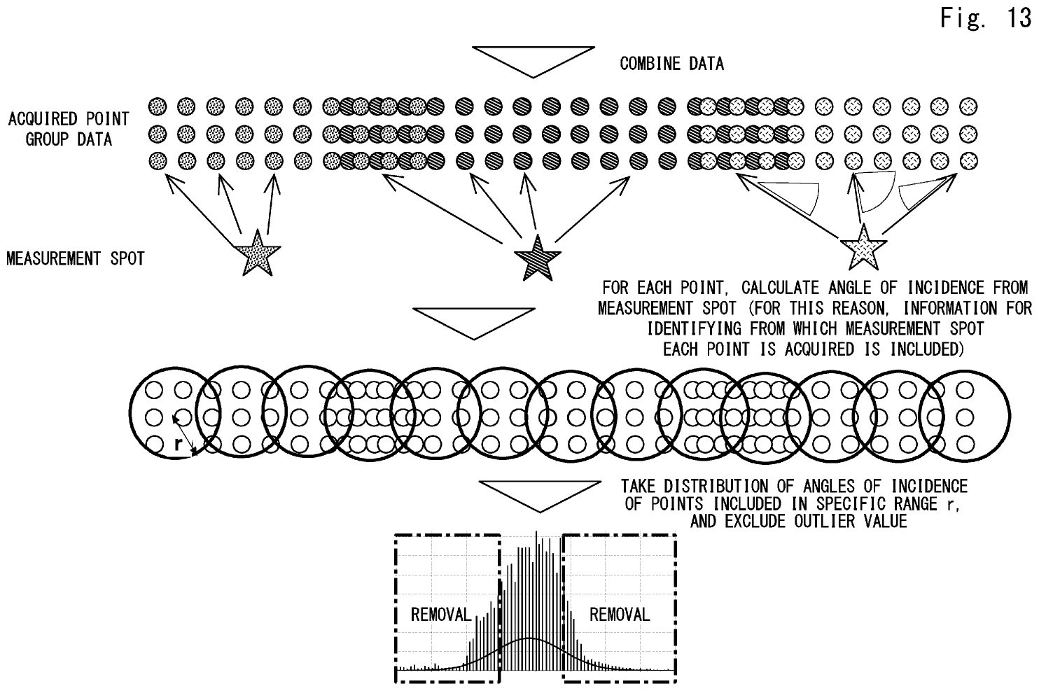

In the example of FIG. 13, the distribution is taken for all the segments and the outlier values are excluded, but the distribution for all the segments is not necessarily taken. In the above example, measurement data are acquired at three measurement spots, but measurement data may be acquired at four or more measurement spots.

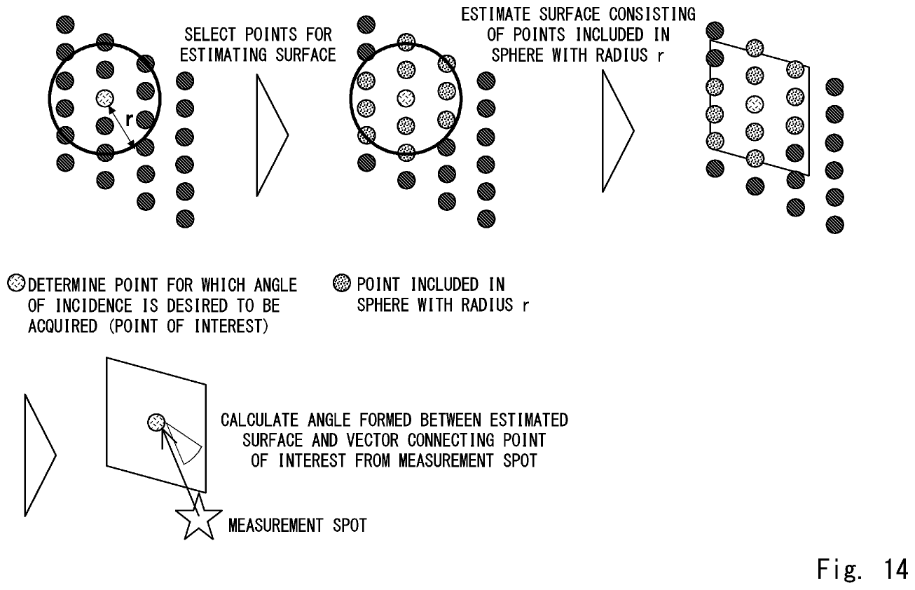

Next, an example of acquiring a distribution of angles of incidence will be explained with reference to FIGS. 13 and 14.

Similar to the calculation example of the distribution of the distances, as illustrated in FIG. 13, when the measurement data acquired at each measurement spot is combined, point group data with the measurement start spot as the origin is acquired. Next, for each point, an angle of incidence of the laser from the measurement spot is calculated. A method of calculating the angle of incidence of the laser will now be explained herein with reference to FIG. 14.

FIG. 14 is a diagram explaining an example of calculation of an angle of incidence of a laser.

A point for which an angle of incidence is desired to be acquired from the point group data (a point of interest) is determined. From the point group data included in the sphere with the radius r from the point of interest, an incidence surface of the laser is estimated. When the estimated surface is a curved surface, a plane surface in which the curved surface and the point of interest are in contact with each other can be estimated as the incidence surface. Finally, an angle formed between the estimated surface and a vector connecting the point of interest from the measurement spot is calculated. In this way, the angle of incidence can be calculated for a large number of points.

Returning again to FIG. 13, the explanation of acquiring the distribution of the angles of incidence will be continued. For each point, the angle of incidence from the measurement spot is calculated. In this case, the point group data may include information for identifying from which measurement spot each point is acquired by the laser. For example, the point group data include the acquired time, and it is possible to recognize at which measurement position (measurement points A, B, and C in FIG. 11) each point is acquired, in light of a predetermined path and time.

Next, as described above, the point group data of the object to be measured are divided into small segments. For each segment, a distribution of angles of incidence from the measurement spot to the measurement point is taken, and the outlier values are excluded. As described above, it is possible to remove, from the distribution thus acquired, those exceeding a predetermined threshold value (for example, standard deviations σ, 2σ, 3σ, etc.) from the average value. By taking the distribution and excluding the outliers for all segments, it is possible to acquire optimum point group data in which unnecessary data are removed even when the sensor is moved. For example, by removing data having a remarkably large angle of incidence and data having a remarkably small angle of incidence, it is possible to acquire point group data in which variation is suppressed as illustrated in FIG. 6. Further, for example, in the case of the example of FIG. 9, the inner wall 6d and the inclined surface 6e are each divided into separate segments, and the distribution of the angles of incidence between the measurement spot and each point is calculated for each segment. In this way, it is possible to prevent the uniform removal of the measurement data relating to the inner wall 6e that is an inclined surface, such as filtering by a fixed threshold value.

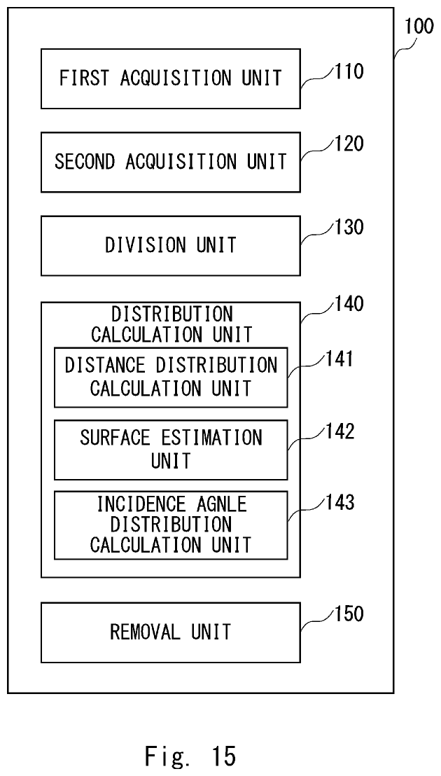

FIG. 15 is a block diagram illustrating a configuration of an information processing apparatus 100 according to the second example embodiment.

The information processing apparatus 100 according to the present example embodiment can be achieved by a computer that analyzes point group data acquired by a sensor mounted on a moving body. The information processing apparatus 100 is usually a computer located at a place different from that of the moving body, but may be a computer mounted on the moving body. In the information processing apparatus 100, the same components as those of the information processing apparatus 100 according to the first example embodiment are denoted by the same reference numerals, and explanation thereof will be omitted as appropriate.

The distribution calculation unit 140 of the information processing apparatus 100 further includes a distance distribution calculation unit 141, a surface estimation unit 142, and an incidence angle distribution calculation unit 143. As explained by using FIGS. 11 and 12, the distance distribution calculation unit 141 calculates a distribution of distances with respect to point group data in each segment. As explained by using FIG. 14, the surface estimation unit 142 estimates a surface from data of distances to a plurality of points around the point of interest. As explained by using FIG. 13, the incidence angle distribution calculation unit 143 calculates the distribution of the angles of incidence with respect to the point group data in each segment.

Furthermore, the removal unit 150 according to the present example embodiment removes an outlier value from the point group data in the segment, based on the distribution of the distances. Additionally or alternatively, the removal unit 150 removes the outlier value from the point group data in the segment, based on the distribution of angles of incidence.

In the information processing apparatus and method according to the second example embodiment explained above, unnecessary data can be removed from the measured point group data by moving the sensor without removing the originally necessary data. Further, by removing unnecessary data based on the acquired distribution of distances and distribution of angles of incidence, more appropriate point group data can be obtained.

### Third Example Embodiment

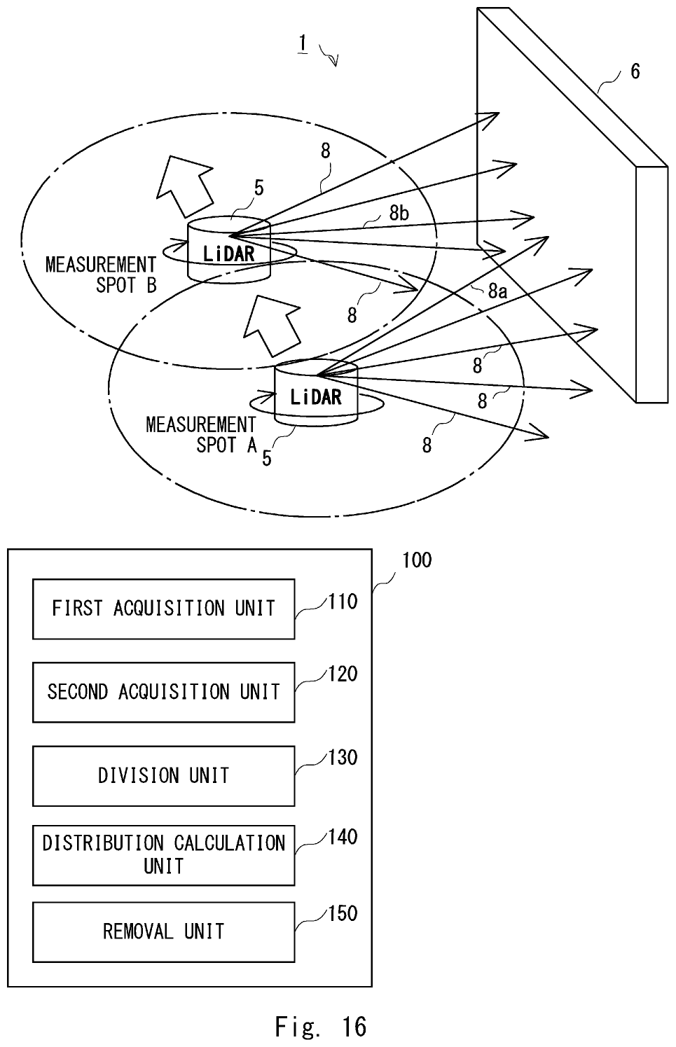

FIG. 16 is a block diagram illustrating a configuration of an information processing system according to a third example embodiment.

The information processing system (also referred to as a measurement system) irradiates an object to be measured 6 with a laser from a sensor 5 while moving the sensor along a path, and the sensor 5 receives reflected light, thereby measuring a distance from the sensor 5 to the object to be measured 6.

The information processing system includes the above-described information processing apparatus 100 and a movable sensor that measures an object to be measured. For example, the information processing apparatus 100 may be mounted on a moving body, and may be integrally configured to include the sensor 5. In this case, the information processing apparatus 100 can remove unnecessary data from the point group data acquired by the sensor. Further, the information processing apparatus 100 includes a wireless communication unit, and can transmit point group data from which unnecessary data are removed, to an external apparatus via a wireless communication network. In this way, communication traffic can be suppressed.

Alternatively, the information processing apparatus 100 may be configured as a separate body from the moving body on which the sensor 5 is mounted. In this case, the information processing apparatus 100 may include a communication unit, receive point group data via a wired or wireless communication network, and store a program for executing the above-described information processing method.

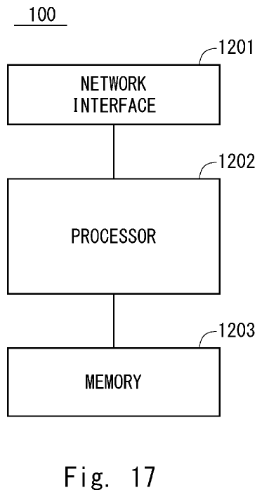

FIG. 17 is a block diagram illustrating an example of a hardware configuration of the information processing apparatus 100. Referring to FIG. 17, the information processing apparatus 100 includes a network interface 1201, a processor 1202, and a memory 1203. The network interface 1201 is used for communicating with other network node apparatuses constituting a communication system. The network interface 1201 may be used for performing wireless communication. For example, the network interface 1201 may be used for performing wireless-LAN communication defined in IEEE 802.11 series or mobile communication defined in 3rd Generation Partnership Project (3GPP). Alternatively, the network interface 1201 may include a network interface card (NIC) compliant with IEEE 802.3 series, for example.

The processor 1202 reads and executes software (a computer program) from the memory 1203, thereby performing processing of the information processing apparatus 100 explained by using the flowchart or the sequence in the above-described example embodiments. The processor 1202 may be, for example, a microprocessor, a micro processing unit (MPU), or a central processing unit (CPU). The processor 1202 may include a plurality of processors.

The memory 1203 includes a combination of a volatile memory and a non-volatile memory. The memory 1203 may include a storage arranged remotely from the processor 1202. In this case, the processor 1202 may access the memory 1203 via an I/O interface that is not illustrated.

In the example of FIG. 17, the memory 1203 is used for storing a group of software modules. The processor 1202 can read a group of these software modules from the memory 1203 and execute the group of the software modules, thereby performing the processing of the information processing apparatus 100 explained in the above-described example embodiments.

As explained by using FIG. 17, each of the processors included in the information processing apparatus 100 or the like executes one or a plurality of programs including an instruction group for causing a computer to execute the algorithm explained by using the drawings.

### Other Example Embodiments

Although the above-described example embodiment has been explained as a hardware configuration, the present invention is not limited thereto. The present disclosure also can achieve optional processing by causing a CPU to execute a computer program.

In the examples described above, the program may be stored and provided to the computer by using various types of non-transitory computer readable media. The non-transitory computer readable media include various types of tangible storage media. Examples of the non-transitory computer readable media include magnetic recording media (for example, flexible disks, magnetic tapes, hard disk drives), magneto-optical recording media (for example, magneto-optical disks), CD-ROM (Read Only Memory), CD-R, CD-R/W, DVD (Digital Versatile Disc), and semiconductor memory (for example, mask ROM, PROM (Programmable ROM), EPROM (Erasable PROM), flash ROM, RAM (Random Access Memory)). The program may also be provided to the computer by various types of transitory computer readable media. Examples of the transitory computer readable media include electrical signals, optical signals, and electromagnetic waves. The transitory computer readable medium can provide the program to the computer via a wired communication path such as an electric wire and an optical fiber, or a wireless communication path.

Note that the present disclosure is not limited to the above-described example embodiments, and can be appropriately modified without departing from the spirit thereof. Further, the present disclosure may be implemented by appropriately combining the example embodiments.

Some or all of the above-described example embodiments may also be described as the following supplementary notes, but are not limited thereto.

### (Supplementary Note 1)

An information processing apparatus comprising:
a first acquisition unit configured to acquire first point group data indicating a distance between a sensor and an object to be measured at a first measurement spot along a path;
a second acquisition unit configured to acquire second point group data indicating a distance between a sensor and the object to be measured at a second measurement spot different from the first measurement spot along the path;
a division unit configured to divide point group data including the first point group data and the second point group data into one or a plurality of segments;
a distribution calculation unit configured to calculate a distribution of the point group data in the segment; and
a removal unit configured to remove an outlier value from the point group data in the segment, based on the distribution.

### (Supplementary Note 2)

The information processing apparatus according to Supplementary note 1, wherein the distribution calculation unit further includes a distance distribution calculation unit configured to calculate a distribution of distances with respect to the point group data in the segment.

### (Supplementary Note 3)

The information processing apparatus according to Supplementary note 1 or 2, wherein
the distribution calculation unit further includes: a surface estimation unit configured to estimate a surface from the point group data in the segment; and
an incidence angle distribution calculation unit configured to calculate a distribution of angles of incidence into the estimated surface with respect to the point group data in the segment.

### (Supplementary Note 4)

The information processing apparatus according to Supplementary note 1, wherein the segment is a sphere of a predetermined size or a voxel of a predetermined size.

### (Supplementary Note 5)

The information processing apparatus according to any one of Supplementary notes 1 to 4, wherein the point group data include a luminance value.

### (Supplementary Note 6)

An information processing system comprising:
a sensor configured to, while moving a sensor along a path, irradiate an object to be measured with a laser from the sensor, receive reflected light, and thereby acquire point group data acquired by measuring a distance from the sensor to the object to be measured;
a first acquisition unit configured to acquire first point group data indicating a distance between the sensor and the object to be measured at a first measurement spot along the path;
a second acquisition unit configured to acquire second point group data indicating a distance between the sensor and the object to be measured at a second measurement spot different from the first measurement spot along the path;
a division unit configured to divide point group data including the first point group data and the second point group data into a plurality of segments;
a distribution calculation unit configured to calculate a distribution of the point group data in the segment; and
a removal unit configured to remove an outlier value from the point group data in the segment, based on the distribution.

### (Supplementary Note 7)

The information processing system according to Supplementary note 6, further comprising a moving body on which the sensor is mounted.

### (Supplementary Note 8)

The information processing system according to Supplementary note 6 or 7, wherein the first acquisition unit and the second acquisition unit are connected to the sensor in such a way as to be able to communicate point group data via a wireless communication network.

### (Supplementary Note 9)

An information processing method comprising:
acquiring first point group data indicating a distance between a sensor and an object to be measured at a first measurement spot along a path;
acquiring second point group data indicating a distance between a sensor and the object to be measured at a second measurement spot different from the first measurement spot along the path;
dividing point group data including the first point group data and the second point group data into one or a plurality of segments;
calculating a distribution of the point group data in the segment; and
removing an outlier value from the point group data in the segment, based on the distribution.

### (Supplementary Note 10)

A non-transitory computer readable medium storing a program that causes a computer to execute:
processing of acquiring first point group data indicating a distance between a sensor and an object to be measured at a first measurement spot along a path;
processing of acquiring second point group data indicating a distance between a sensor and the object to be measured at a second measurement spot different from the first measurement spot along the path;
processing of dividing point group data including the first point group data and the second point group data into one or a plurality of segments;
processing of calculating a distribution of the point group data in the segment; and
processing of removing an outlier value from the point group data in the segment, based on the distribution.

Although the present invention has been explained with reference to the example embodiments (and examples), the present invention is not limited to the above-described example embodiments (and examples). Various modifications that can be understood by a person skilled in the art within the scope of the present invention can be made to the configuration and details of the present invention.

### REFERENCE SIGNS LIST

1 INFORMATION PROCESSING SYSTEM
2 MOVING BODY
5 SENSOR
6 OBJECT TO BE MEASURED
8 LASER
100 INFORMATION PROCESSING APPARATUS
110 FIRST ACQUISITION UNIT
120 SECOND ACQUISITION UNIT
130 DIVISION UNIT
140 DISTRIBUTION CALCULATION UNIT
141 DISTANCE DISTRIBUTION CALCULATION UNIT
142 SURFACE ESTIMATION UNIT
143 INCIDENCE ANGLE DISTRIBUTION CALCULATION UNIT
150 REMOVAL UNIT

What is claimed is:

1. An information processing apparatus comprising:
at least one memory storing instructions, and
at least one processor configured to execute the instructions to;
acquire first point group data indicating a distance between a sensor and an object to be measured at a first measurement spot along a path;
acquire second point group data indicating a distance between a sensor and the object to be measured at a second measurement spot different from the first measurement spot along the path;
divide point group data including the first point group data and the second point group data into one or a plurality of segments;
calculate a distribution of the point group data in the segment; and
remove an outlier value from the point group data in the segment, based on the distribution.

2. The information processing apparatus according to claim 1, wherein the at least one processor configured to execute the instructions to calculate a distribution of distances with respect to the point group data in the segment.

3. The information processing apparatus according to claim 1, wherein the at least one processor configured to execute the instructions to estimate a surface from the point group data in the segment; and
calculate a distribution of angles of incidence into the estimated surface with respect to the point group data in the segment.

4. The information processing apparatus according to claim 1, wherein the segment is a sphere of a predetermined size or a voxel of a predetermined size.

5. The information processing apparatus according to claim 1, wherein the point group data include a luminance value.

6. An information processing system comprising:
a sensor configured to, while moving a sensor along a path, irradiate an object to be measured with a laser from the sensor, receive reflected light, and thereby acquire point group data acquired by measuring a distance from the sensor to the object to be measured; and
the information processing apparatus according to of claim 1.

7. The information processing system according to claim 6, further comprising a moving body on which the sensor is mounted.

8. The information processing system according to claim 6, wherein the information processing apparatus are connected to the sensor in such a way as to be able to communicate point group data via a wireless communication network.

9. An information processing method comprising:
acquiring first point group data indicating a distance between a sensor and an object to be measured at a first measurement spot along a path;
acquiring second point group data indicating a distance between a sensor and the object to be measured at a second measurement spot different from the first measurement spot along the path;
dividing point group data including the first point group data and the second point group data into one or a plurality of segments;
calculating a distribution of the point group data in the segment; and
removing an outlier value from the point group data in the segment, based on the distribution.

10. A non-transitory computer readable medium storing a program that causes a computer to execute:
processing of acquiring first point group data indicating a distance between a sensor and an object to be measured at a first measurement spot along a path;
processing of acquiring second point group data indicating a distance between a sensor and the object to be measured at a second measurement spot different from the first measurement spot along the path;
processing of dividing point group data including the first point group data and the second point group data into one or a plurality of segments;
processing of calculating a distribution of the point group data in the segment; and
processing of removing an outlier value from the point group data in the segment, based on the distribution.
